(19) United States
(12) Patent Application Publication
(10) Pub. No.: US 2010/0173059 A1
(43) Pub. Date: Jul. 8, 2010

(54) High speed citrus juice extraction method and apparatus

(76) Inventor: John A. Lambert, Clermont, FL (US)

Correspondence Address: Bruce H. Johnsonbaugh;Eckhoff & Hoppe, 8th Floor, 1990 North California Boulevard, Walnut Creek, CA, 94596, US

(21) Appl. No.: 12/655,416

(22) Filed: Dec. 30, 2009

Related U.S. Application Data
(60) Provisional application No. 61/204,319, filed on Jan. 5, 2009.

(51) Int. Cl. A47J 19/02; A23L 2/06

(52) U.S. Cl. 426/489; 99/502; 99/506

(57) ABSTRACT

A high speed method and apparatus for citrus juice extraction is provided. The juice extraction system includes a reamer having a plurality of diagonal grooves formed in the surface of the primary rib or ribs of the reamer. The grooves allow juice to escape easily, which in turn allows the reamer to extract over 99% of the citrus juice.

### CROSS REFERENCE TO RELATED APPLICATION

This application claims the benefit of and priority from U.S. provisional application Ser. No. 61/204,319 filed Jan. 5, 2009.

### BACKGROUND AND SUMMARY OF INVENTION

The present invention relates to automatic citrus juice extractors. More particularly, the invention relates to high speed, automatic orange juice (and other citrus juice) extractors, such as shown in U.S. Pat. Nos. 5,269,218; 5,188,021; 4,759,938 and 3,858,500 all of which are incorporated herein by reference, and all of which are owned by the assignee of the present application. The following disclosure is specific to oranges, but the invention applies to all citrus fruit.

The most persistent problem with prior art automatic, high speed orange juice extractors is that the highest quality juice (having the greatest sugar content) is contained in the juice sacs or cells that are adjacent the peel. The peel contains objectionable solids and oils. If the juice extractor pierces these sacs or cells and then invades the peel, the extracted high quality juice is seriously downgraded by being intermingled with fragments and oil from the peel.

A related, and equally serious, problem with prior art automatic orange juice extractors is if the extraction mechanism (typically a hemispheric reamer) is adjusted to avoid invasion of the peel, most, if not all, of the highest quality juice remains in the relatively small juice cells adjacent the peel and is lost.

A significant aspect of the present invention is the recognition, or discovery, that prior art hemispherical reamers encounter a “fluid barrier” as they approach the outermost, high quality but small juice cells adjacent the peel. As shown and described below, this “fluid barrier” causes the prior art hemispherical reamers to “slip” (i.e. to lose frictional engagement with the citrus flesh) or to rotate without advancing into the highest quality juice cells.

The present invention provides, for the first time, an orange (and other citrus fruit) juice extraction method and mechanism that overcomes the problems described above. As shown and described in greater detail below, the present invention overcomes the “fluid barrier” described above, and simultaneously allows a modified hemispherical reamer to enter the highest quality, small juice cells adjacent the peel and extract the best juice, all without invading the peel! Prior art extractors have been leaving approximately 3-5% of the total juice with the peel. The present reamer design leaves less than 1% of the total juice with the peel!! The present reamer design therefore extracts at least 66% of the juice left behind by prior art extractors. In other words, the present juice extractor, for the first time, extracts more than 99% of the citrus juice at high speeds, without invading the peel!!

The present invention achieves these results by utilizing a series of specially designed transverse grooves in the major or primary ribs of the reamer head. These grooves achieve two critical functions for the first time in this art. First, the grooves provide a drain or escape for the liquids in the “fluid barrier” described above. Second, the grooves include edges that are strategically positioned to pierce the juice cells adjacent the peel without causing the reamer head to enter the peel!

The result of the present invention is an automatic, high speed citrus juice extractor that is capable of achieving a significantly higher yield of high quality orange juice (and other citrus juices) that is free from objectionable amounts of peel fragments and peel oil.

The present invention achieves the aforementioned results by using a novel reamer that may be easily retrofitted into existing juice extractors.
The prior art includes the four patents noted above. Those patents teach various automatic, high speed extractors capable of extracting juice from 600 or more citrus fruit per minute. These prior art extractors teach various mechanisms for moving citrus fruit through the machine, slicing the fruit into halves, supporting the citrus halves in holding cups, and causing a reamer to have relative motion against the citrus half to extract juice (and pulp). These extractors use reamers that are dome shaped or hemispherical shaped. The reamers have ribs formed on their surfaces, but otherwise the reamer surface is relatively smooth.

The present invention departs from those prior art mechanisms by having a plurality of grooves formed transversely across some or all of the ribs of the reamer, as shown and described below.

The prior art also includes reamers that have roughened or sharpened cutting surfaces. For example, U.S. Pat. Nos. 6,258,093 and 5,376,092 teach surgical reamers for enlarging bone canals or forming hip sockets. Although these surgical reamers have a superficial resemblance to the present reamer design, they are used for different purposes to overcome different problems. Both are used for cutting into hard bone and to make those cuts with minimized heat generated and in minimum time. The “fluid barrier” problem encountered in citrus juice extractors simply does not occur with hard bone.

The prior art also includes US 2007/0277380, which teaches a hand held and powered citrus juicer. This is a manual device, usable on one citrus half at a time. The user simply presses the extractor head into the citrus half. The device provides no feature for determining how deep to drive the extractor into the citrus half. The shape of the extractor head suggests that the user must use a circular motion inside the citrus half to follow the circumference of the peel. The present invention uses a hemispherical, dome shaped reamer that automatically moves on a straight axis relative to the citrus half.

A primary object of the invention is to provide a high speed, automatic citrus juice extraction method and apparatus capable of extracting more than 99% of the citrus juice without also extracting objectionable amounts of peel oil or peel fragments.

A further object of the invention is to recognize the problem of a “fluid barrier” formed in citrus halves being processed in automatic citrus juice extractors and to overcome that problem.

A further object of the invention is to provide an improved citrus juice extraction mechanism that can be easily retrofitted into existing citrus juice extractors.

Another object of the invention is to provide transverse, diagonally oriented grooves in primary ribs of an automatic, high speed citrus juice extractor to more efficiently remove juice and pulp solids during the juice extraction process.

A further object of the invention is to provide a high speed (i.e. more than 600 citrus fruit per minute), automatic citrus juice extractor capable of piercing and extracting juice from the relatively small juice sacs or cells adjacent the citrus peel, all without invading the peel.

Other objects and advantages will become apparent from the following description and drawings.

### BRIEF DESCRIPTION OF THE DRAWINGS

FIGS. 1A-1D illustrate portions of a prior art citrus juice extractor wherein a reamer assembly is driven into a holding cup assembly;

FIGS. 2A-2B illustrate portions of a prior art citrus juice extractor having a holding cup assembly with a plurality of holding cups wherein the holding cups are driven against a reamer assembly;

FIG. 3A illustrates a quadrant of a sliced orange half, showing the cell boundaries in exaggerated form;

FIG. 3B illustrates a sliced orange half, again exaggerating the cell boundaries;

FIG. 3C is a photograph of a sliced orange half;

FIG. 4 illustrates a prior art reamer as it moves into an orange half;

FIG. 5 illustrates the prior art reamer of FIG. 4 showing how juice fluid starts accumulating between the reamer and peel;

FIG. 6 illustrates the prior art reamer of FIGS. 4 and 5 showing the “fluid barrier” that causes relative motion between the reamer and peel to stop;

FIG. 7 is a perspective view of a typical prior art reamer;

FIG. 8 is a perspective view of the reamer of the present invention;

FIG. 9 illustrates how the reamer of the present invention overcomes the “fluid barrier” problem shown in FIG. 6;

FIG. 10 illustrates how the reamer of the invention engages and ruptures the small juice cells adjacent the peel;

FIG. 11 illustrates the present reamer as it reaches the peel and stops; and

FIG. 12 illustrates a preferred insert on which the new reamer is carried.

### DETAILED DESCRIPTION OF THE DRAWING

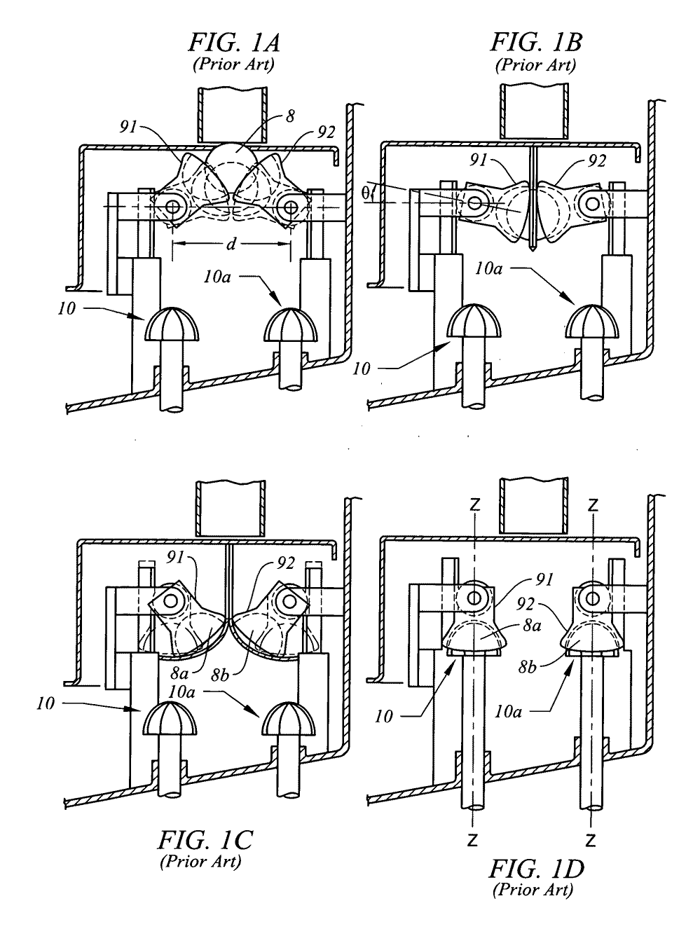

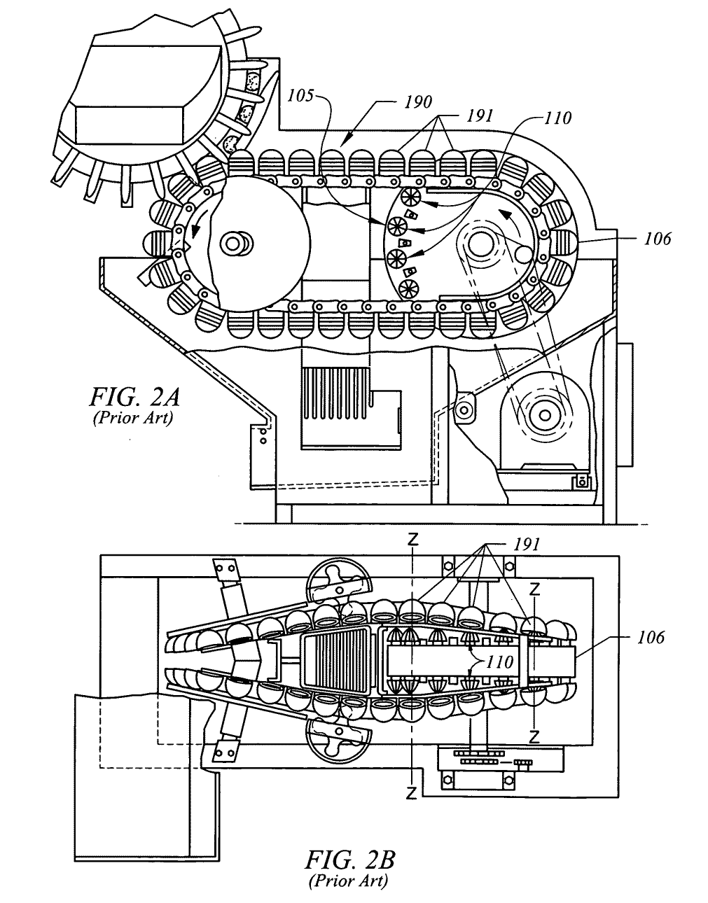

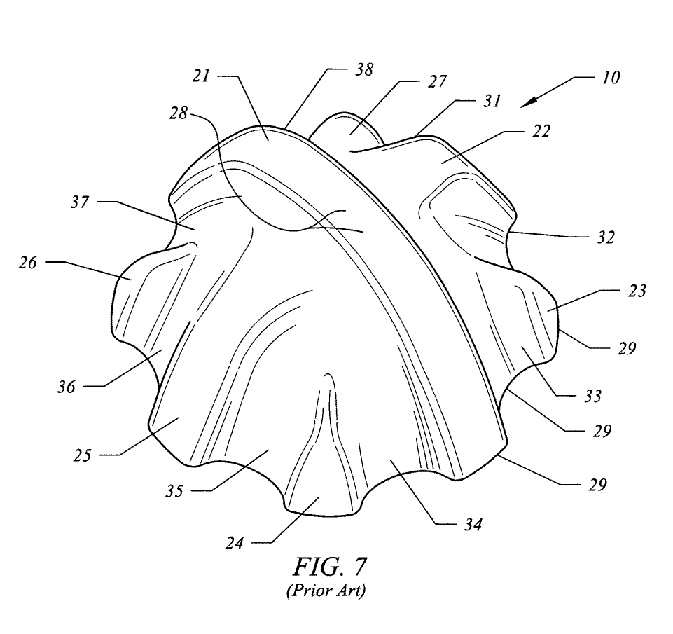

FIGS. 1A-1D and FIGS. 2A-2B illustrate portions of two prior art juice extractors. FIGS. 1A-1D are reproductions of FIGS. 7-10 of U.S. Pat. No. 5,188,021, with original reference numbers deleted and new reference numbers used for clarity. FIGS. 2A-2B are reproductions of FIGS. 1&2 of U.S. Pat. No. 4,759,938, with original reference numbers deleted and new reference numbers used for clarity.

FIGS. 1A-1D and 2A-2B are intended to show the working environment of prior art reamers in two juice extraction mechanisms. FIGS. 1A-1D shows how citrus fruit 8 (an orange) is transported automatically to a pair of pivotal cup holders 91,92 (FIG. 1A), is sliced into halves (FIG. 1B), and positioned for reaming above reamers 10, 10a (FIG. 1C). In FIG. 1D, reamers 10,10a rotate about axes Z-Z and are periodically driven along axes Z-Z into citrus halves 8a, 8b to extract the citrus juice. Other aspects of the juice extractor are omitted here for the sake of brevity, but are described in U.S. Pat. No. 5,188,021.

FIGS. 2A-2B show a second prior art juice extractor wherein an annular carousel 190 with a plurality of circumferentially arranged holding cups 191 interacts with an assembly 105 having a plurality of reamers 110. The reamer assembly 105 is smaller than carousel 190. As shown best in FIG. 2B, relative motion along the Z-Z axes is achieved between the holding cups 191 and reamers 110, since the holding cups 191 are driven along axes Z-Z into the reamers 110 and reach maximum depth at point 106. Again, other aspects of the extractor are omitted here for the sake of brevity, but are described in U.S. Pat. No. 4,759,938.

FIGS. 1A-1D and 2A-2B illustrate how the prior art reamers and cup holders are caused to move along axes Z-Z relative to each other to force the reamers into the citrus halves. These figures (and patents) illustrate and describe the automatic mechanisms used to deliver citrus fruits at high speeds (i.e. more than 600 citrus fruit per minute) to the cup holders and reamers. The individual reamers typically are driven into and removed from each citrus half in less than 0.5 second.

As noted above, the prior art extractors typically would leave about 3-5% of the juice behind with the peel. This loss was easily confirmed by inspection of the discharged peels. A significant aspect of the present invention was the discovery or realization of why this significant amount of high quality juice was being lost.

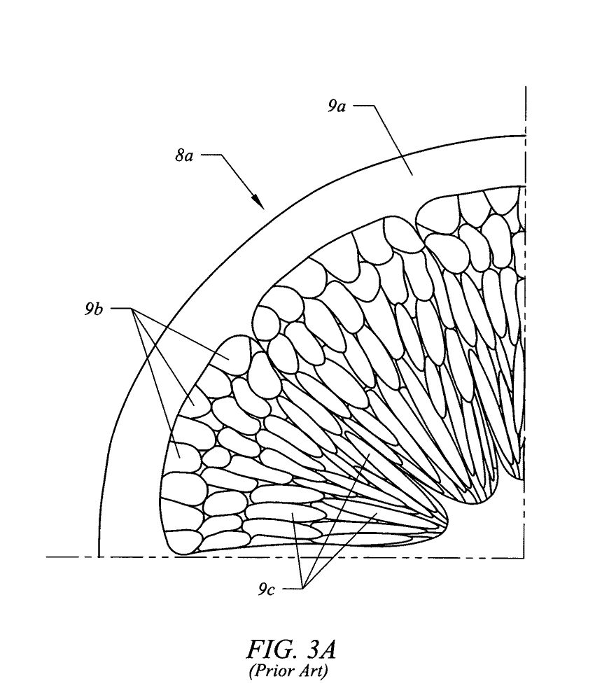

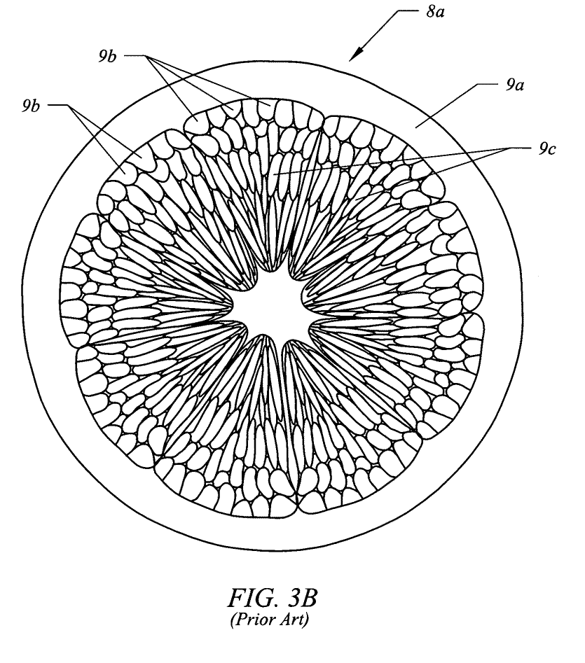

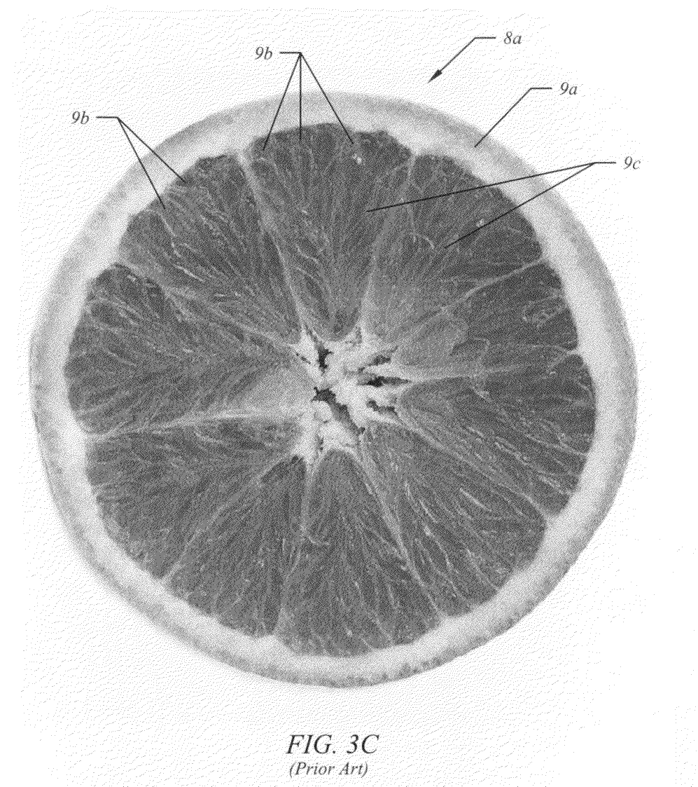

FIGS. 3-6 are schematic illustrations (not to scale) showing why the aforementioned loss was occurring in prior art juice extractors. The cup holders are not shown for clarity.

FIG. 3A illustrates a quadrant of a typical orange half 8a. The juice cell boundaries are exaggerated somewhat to illustrate the differences between cells. The peel 9a contains objectionable oils and solids. The high quality juice cells 9b lie next to peel 9a, and are typically relatively smaller and rounder than the lower quality, elongated juice cells or sacs 9c near the center of orange half 8a.

FIG. 3B illustrates orange half 8a, again exaggerating cell boundaries as in FIG. 3A.

FIG. 3C is a black and white photograph of a typical orange half 8a, with many of the cell boundaries visible. The smaller, rounder cells 9b are adjacent peel 9a. Elongated cells or sacs 9c are near the center of orange half 8a.

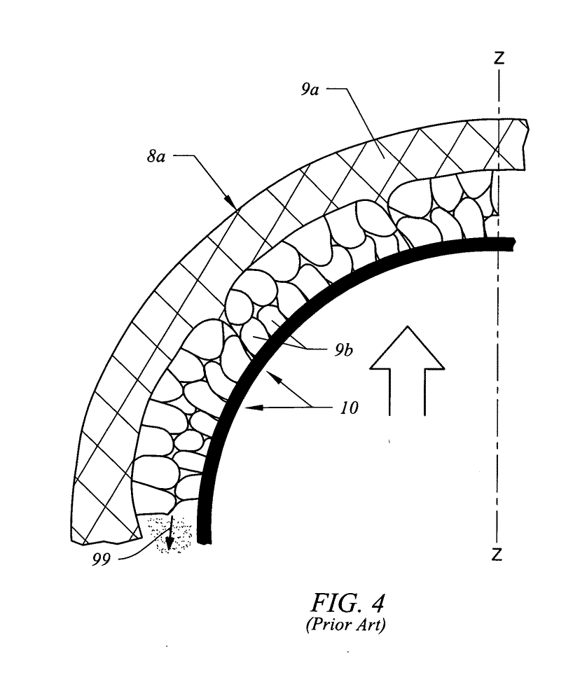

FIG. 4 illustrates a portion of a typical, prior art reamer 10 moving relative to the quadrant of orange 8a shown. Reamer 10 has ruptured most of the elongated cells 9c. Extracted juice is expelled between the reamer 10 and peel 9a as shown by arrow 99.

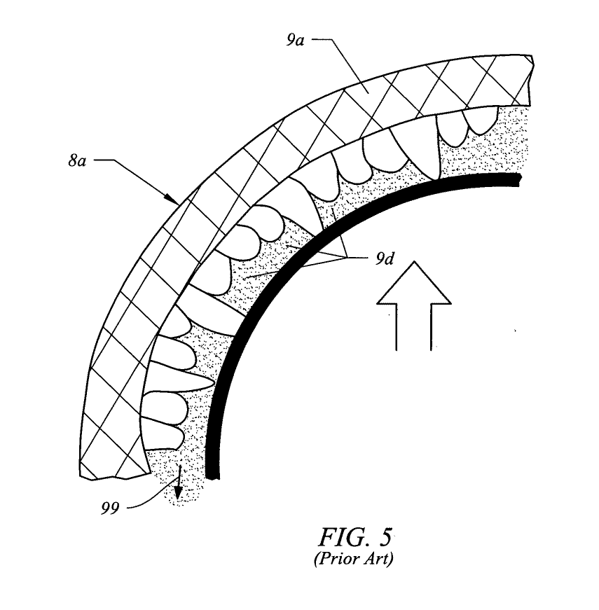

FIG. 5 illustrates how juice 9d from ruptured cells accumulates between reamer 10 and peel 9a. Because of the relatively short time (less than 0.5 second) available for reamer 10 to complete its cycle juice 9d accumulates between reamer 10 and peel 9a faster than it is expelled as shown by arrow 99.

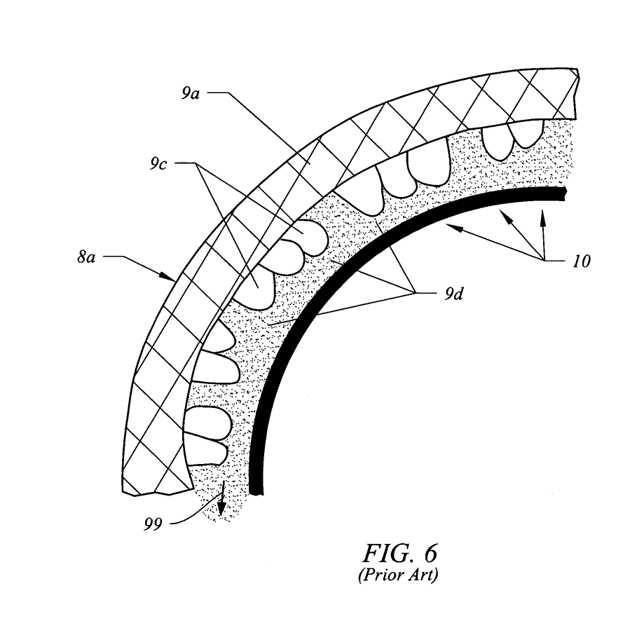

FIG. 6 illustrates the “fluid barrier” 9d referred to above, which is juice from ruptured cells that has accumulated between reamer 10 and peel 9a faster than being expelled as shown by arrow 99. Either reamer 10 or the cup holder (not shown in FIG. 6) is designed to move on axis Z-Z with a given force. When that force has been applied, as shown in FIG. 6, the relative motion on the Z-Z axis stops, as shown in FIG. 6. When the “fluid barrier” has stopped the relative motion of the reamer 10 against the peel 9a, a significant number of the smaller cells 9c remain intact against peel 9a. Those intact cells 9c remain with peel 9a when reamer 10 is retracted, and are lost.

FIG. 7 is a perspective view of a typical prior art reamer shown generally as 10. The reamer 10 has a generally dome shaped or hemispherical surface having a plurality of ribs 21-27 separated by recesses 31-38 formed between adjacent ribs. The surfaces of prior art ribs 21-27 are smooth, flat in the transverse direction and arcuate in their longitudinal direction. The edges between the surfaces of ribs 21-27 and recesses 31-38 bear against the citrus fruit flesh and peel during the reaming operation. Solids and liquids are expelled along the recesses 31-38. The tip end 28 of reamer 10 is smooth, and tends to act as a “brake” when and if it contacts the peel. Reamer 10 has a skirt end 29 that forms its back end. The ribs 21-27 and recesses 31-38 extend from the tip end 28 away from the tip end to the skirt end 29 of reamer 10.

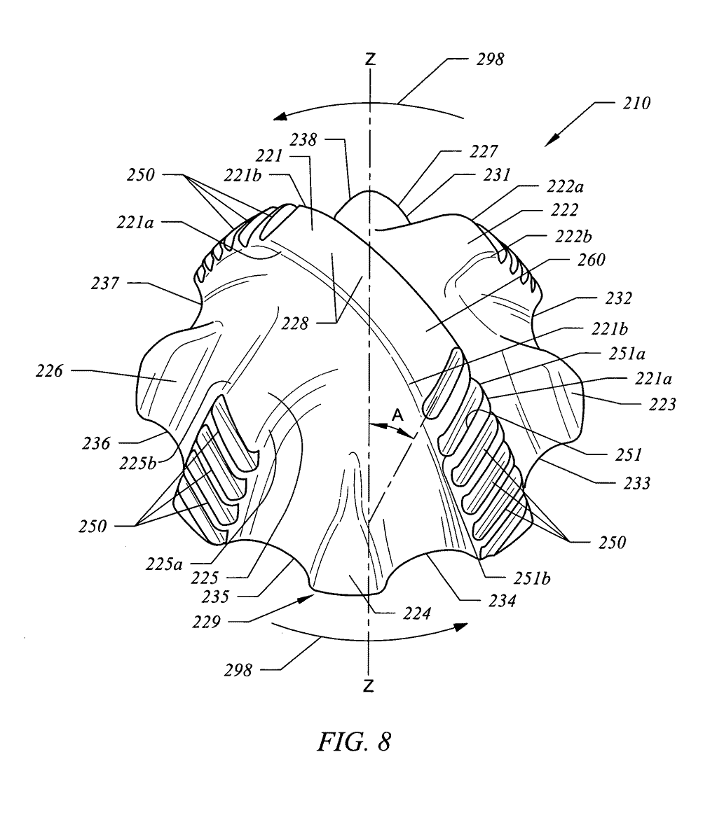

FIG. 8 is a perspective view of the reamer 210 of the present invention. Ribs 221-227 and recesses 231-238 are formed similarly to ribs 21-27 and recesses 31-38 shown in the prior art reamer of FIG. 7. Each primary rib 221,222 and 225 has a leading edge 221a, 222a, and 225a, respectively, which contacts and ruptures juice cells. Each primary rib 221,222 and 225 has a trailing edge 221b, 222b and 225b, respectively. The leading edge 221a and trailing edge 221b of rib 221 each subtends an arc of about 180°, since rib 221 extends across the tip end 228 of reamer 210. Ribs 222 and 225 each subtend an arc of less than 90°, since they do not extend to the tip end 228 of reamer 210. As reamer 210 rotates around axis Z-Z in the direction of arrows 298, the leading edge 221a tends to force juice from ruptured cells forwardly in the direction of rotation into “first” recesses 233 and 237. According to the present invention, the primary ribs of reamer 210, i.e., ribs 221,222 and 225 have a plurality of diagonally oriented grooves 250 formed in their surfaces. Each groove 250 preferably has sharp edges such as 251 formed in the leading edge 221a of rib 221, and in the leading edges 222a and 225a of ribs 222,225. Each groove 250 extends transversely across the surface of the rib to allow fluid communication through each groove and to allow liquid to flow from each “first” recess lying forwardly of the rib, through the groove 250, into a “second” recess 231-238, lying adjacent to, but behind, the trailing edge of the rib. The main ribs, i.e., ribs 221,222 and 225 may protrude outwardly further than secondary ribs 223,224,226, and 227 to allow grooves 250 to contact the citrus product before the secondary ribs (223,224,226,227) contact the citrus product. Each groove 250 forms an angle A with axis Z-Z of between 30° and 60°, and preferably between 40° and 50°. Each groove has a rectangular cross section, a width between 0.5 mm-1.5 mm and a depth between 0.5 mm-1.5 mm. The preferred design shown in FIG. 8 includes a total of 20 grooves. The total cross-sectional areas of all 20 grooves is between 5 and 50 mm². It has been found that this range of cross-sectional areas has been adequate to prevent the “fluid barrier” described above.

As shown best in FIG. 8, each of the grooves such as individual groove 251 has an entry 251a on the leading edge 221a of the rib 221 and an exit 251b on the trailing edge 221b of rib 221. The entry of each groove is closer to tip end 228 of reamer 210 that than the skirt end 229. This orientation of the grooves tends to force the juice away from the tip end 228 toward the skirt 229 of reamer 210.

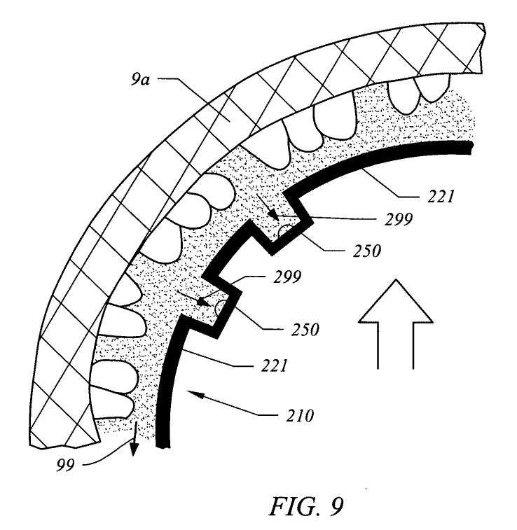

FIGS. 9-11 illustrate in simplified form how the reamer 210 of the present invention overcomes the “fluid barrier” problem of the prior art as illustrated in FIG. 6. As shown in FIG. 9, the grooves 250 formed in the surface of at least one primary rib 221 allow juice to escape from a “first” recess ahead of the rib, by flowing through grooves 250 into a “second” recess on the opposite side of the rib 221, as shown by arrows 299. Juice is also escaping between reamer 210 and peel 9a as shown by arrow 99. Sufficient juice flows through grooves 250 to prevent a “fluid barrier” from forming.

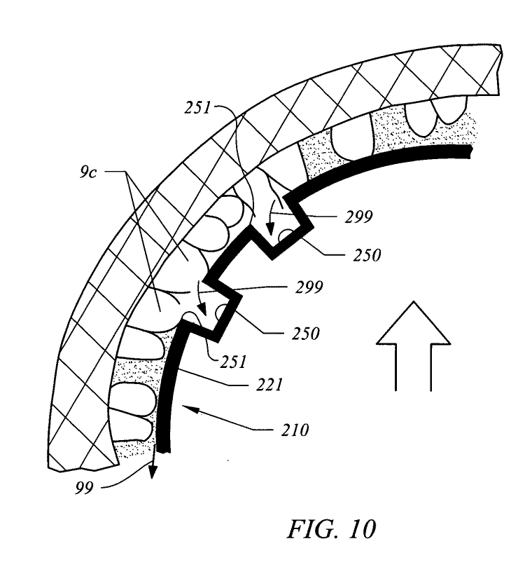

FIG. 10 shows how reamer 210 is now free to engage the smaller cells 9c adjacent peel 9a. The leading, sharp edges 251 of each groove 250 easily rupture the surfaces of cells 9c and juice from those cells flows outwardly through grooves 250 (and outwardly between reamer 210 and peel 9a as shown by arrow 99).

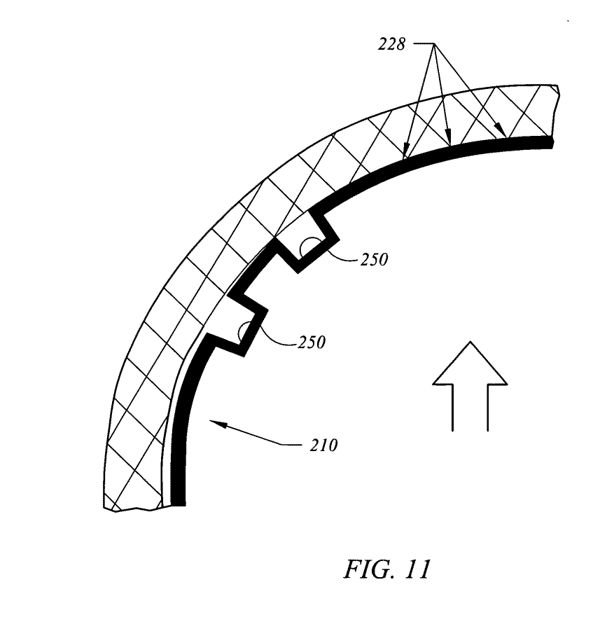

FIG. 11 illustrates how the smooth, tip end 228 contacts the peel 9a and acts as a “brake” to prevent reamer 210 from invading the peel 9a.

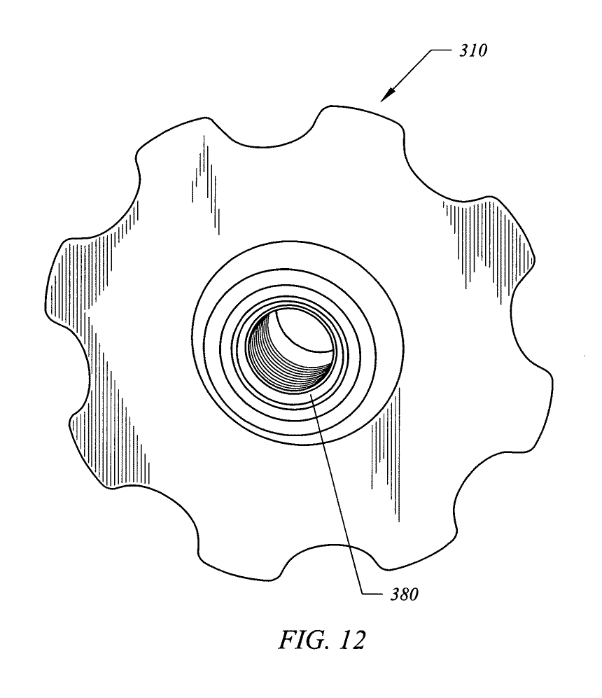

The reamer of the present invention is intended for use with either a rotary or stationary reamer head that has multiple attachment points for the reamer. As shown in FIG. 12, the reamer 310 includes a stainless steel threaded insert 380. Insert 380 is a fixed component molded into the reamer 310. The molded reamer 310 can be a variety of materials, preferably rubber or plastic. The reamer 310 is attached to the reamer head by screwing the embedded threaded insert 380 onto the multiple threaded attachment points found on a conventional reamer head. The entire assembly is then used during the juice extraction process. Prepared citrus products are then introduced to the reamer and the reamer rotates around its axis to remove the internal solids and liquids from the citrus product. The reamer shown and described herein may be used in citrus juice extractors shown in U.S. Pat. Nos. 3,858,500; 4,759,938; 5,269,218 and 5,188,021; all of which are owned by the assignee of this application.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. In an automatic apparatus for extracting juice from citrus fruit at high speeds, wherein a plurality of holding cups is positioned so that each holding cup supports a half of a citrus fruit temporarily, wherein a reamer assembly carries one or more generally dome shaped reamers, each reamer rotating about an axis Z-Z and having a tip end and a skirt end, wherein each of said reamers and each of said holding cups are mounted for periodic, relative motion along said Z-Z axis toward and away from each other, and wherein juice is extracted from said citrus half by said reamer rotating and moving relative to said citrus half toward the citrus peel, the improvement comprising:
each said dome shaped reamer having:
a smooth tip end and one or more primary ribs extending from said smooth tip end toward said skirt end,
each of said primary ribs having a leading edge which contacts and ruptures juice cells, and having a trailing edge,
first and second recesses formed in the surface of said reamer on both sides of said primary rib or ribs, said recesses extending to said skirt end, and
one or more grooves formed in the surface of at least one primary rib and extending transversely across said rib to allow fluid to flow through said groove or grooves, whereby fluid build
up and fluid pressure otherwise formed between said reamer and said peel is minimized by fluid flowing from said first recess through said groove or grooves, past said trailing edge of said primary rib and into said second recess.

2. The apparatus of claim 1 wherein said groove or grooves form an angle A with said axis of rotation Z-Z of between 30° and 60°.

3. The apparatus of claim 2 wherein said angle A is between 40° and 50°.

4. The apparatus of claim 1 wherein a first primary rib extends across said tip end of said reamer and extends to said skirt end of said reamer.

5. The apparatus of claim 1 wherein each reamer head has a second primary rib extending from said tip end to said skirt end of said reamer.

6. The apparatus of claim 5 wherein each rib has a plurality of said grooves formed therein.

7. The apparatus of claim 5 wherein said reamer head has a plurality of secondary ribs formed between said primary ribs.

8. The apparatus of claim 1 wherein said groove or grooves are formed with sharp edges.

9. The apparatus of claim 8 wherein said grooves are rectangular in cross section.

10. A method for high speed, automatic extraction of juice from citrus fruit, wherein a plurality of holding cups supports a citrus half in each cup, wherein one or more reamers are mounted for rotation about an axis Z-Z, wherein drive mechanisms cause relative motion between said reamer or reamers and said holding cups so that said reamers engage said citrus halves to extract juice therefrom, wherein each reamer is generally dome shaped, and having a tip end and a skirt end, and wherein each reamer has one or more primary ribs extending from said tip end toward said skirt end and first and second recesses formed on both sides of each of said primary ribs, comprising the steps:
causing said reamer to advance into said citrus half toward the peel of said citrus half, and
providing fluid communication between said first recess on one side of at least one primary rib to said second recess on the second side of said primary rib to minimize or prevent the buildup of fluid pressure between said reamer and said peel.

11. The method of claim 10 wherein said reamer has a smooth tip end which acts as a brake to stop the relative motion between said holding cup and said reamer on said Z-Z axis when said smooth tip end contacts the peel of said citrus half.
